(19) United States
(12) Patent Application Publication
(10) Pub. No.: US 2020/0073695 A1
(43) Pub. Date: Mar. 5, 2020

(54) SYSTEM AND METHOD OF MANAGING A HARDWARE SWITCH AND A HYPERVISOR AS ONE LOGICAL ENTITY

(71) Applicant: PHYSICAL EDGES SOFTWARE INCOPORATED, Anaheim, CA (US)

(72) Inventors: Salem G. ALSALEM, Yorba Linda, CA (US); Caleb TUCKER, Yorba Linda, CA (US)

(73) Assignee: PHYSICAL EDGES SOFTWARE INCOPORATED, Anaheim, CA (US)

(21) Appl. No.: 16/557,620

(22) Filed: Aug. 30, 2019

Related U.S. Application Data
(60) Provisional application No. 62/725,963, filed on Aug. 31, 2018.

(51) Int. Cl. G06F 9/455

(52) U.S. Cl. CPC G06F 9/45558; G06F 2009/45595

(57) ABSTRACT

A system, apparatus, and method of managing disparate physical components for virtual machine networking as one logical entity.

### CROSS REFERENCE TO RELATED APPLICATIONS

This application claims priority to U.S. Provisional Application No. 62/725,963, filed Aug. 31, 2018, which is incorporated by reference herein in its entirety.

### BACKGROUND

### Field of the Disclosure

Aspects of the disclosure relate in general to managing disparate physical components for virtual machine networking as one logical entity.

### Description of the Related Art

In traditional infrastructure technology environments, networks are managed using discrete interfaces to various networking components. These typically consist of routers, switches, wireless access points, and wireless wide-area network connection equipment.

To accommodate for virtualized components, logical switches within the hypervisor are managed using the hypervisor management solution. This varies from the management solution various hardware original equipment manufacturers (OEMs) use for their products.

As a result, the systems administrators must be familiar with, and have intimate knowledge of the various network management solutions, and of their discrete environment's topology to effectively manage the network stack.

### SUMMARY

Embodiments include a system and method of managing disparate physical components for virtual machine networking as one logical entity.

### DETAILED DESCRIPTION

Aspects of the present disclosure include a system and method include an apparatus and method of managing disparate physical components for virtual machine networking as one logical entity.

Embodiments include a solution to comprehensively manage the various networking components as one logical unit, simplifying the configuration. Each network change in the network at any one level automatically configures the intermediate components to facilitate the change requested by the user.

These changes are simplified in their representation by the management pane, such as exposing the end-ports on a switch at the same layer as the virtual ports on the various virtual machines.

The embodiment comprises a management pane and a software daemon. The management pane is a user-interface that represents all of the networking components as one logical entity, regardless of the type or component to be managed. The software daemon interprets the user's instructions into commands for each of the various components, and executes those commands to drive the end-result. In some embodiments, the embodiments include:
a converged switch/hypervisor,
a single hypervisor/switch management platform,
a converged 4 G/uCPE,
push/activated VPN Keys,
self-registration and auto-provisioning, and/or
auto-networking.

The previous description of the embodiments is provided to enable any person skilled in the art to practice the disclosure. Thus, the present disclosure is not intended to be limited to the embodiments shown herein, but is to be accorded the widest scope consistent with the principles and features disclosed herein.

What is claimed is:

1. A system of managing disparate physical components for virtual machine networking as one logical entity.

2. A method of managing disparate physical components for virtual machine networking as one logical entity.
